(19) United States
(12) Patent Application Publication
(10) Pub. No.: US 2026/0311097 A1
(43) Pub. Date: Oct. 8, 2026

(54) PERSONALIZED PREPAREDNESS SCORING AND PLANNING PLATFORM WITH MULTI-USER COORDINATION AND MODULAR SCORING ARCHITECTURE

(71) Applicant: Sean William Muir, Albany, OR (US)

(72) Inventor: Sean William Muir, Albany, OR (US)

(21) Appl. No.: 19/574,773

(22) Filed: Mar. 23, 2026

Related U.S. Application Data
(60) Provisional application No. 63/776,229, filed on Mar. 23, 2025.

(51) Int. Cl. G06Q 10/0637; G06Q 90/00

(52) U.S. Cl. CPC G06Q 10/0637; G06Q 90/00

(57) ABSTRACT

A computer-implemented platform for personalized emergency preparedness scoring and planning. The platform receives, for one or more users associated with one or more geographic locations, three classes of input: location-specific hazard data from external sources, user-specified preparedness preferences and priorities, and critical dependency data identifying resources or conditions upon which the user depends during emergencies. A modular scoring engine comprising pluggable sub-score computation units and an aggregation unit computes a composite preparedness score and sub-scores across preparedness dimensions. A planning engine generates prioritized preparedness plans with action items mapped to sub-score improvements and constrained by user preferences. The platform supports multi-user and multi-location coordination with cross-location dependency tracking, role-based access, and aggregate scoring. Offline operation with local scoring and conflict-resolving synchronization is provided. A feedback loop re-computes scores and re-prioritizes plans as users complete recommended actions.

### CROSS-REFERENCE TO RELATED APPLICATIONS

This application claims the benefit of U.S. Provisional Application No. 63/776,229, filed Mar. 23, 2025, entitled “System and Method for Personalized Emergency Preparedness Assessment Based on Inventory, Location Risk Factors, and User-Specified Priorities” the entire disclosure of which is hereby incorporated by reference.

### FIELD OF THE INVENTION

The present invention relates generally to computer-implemented systems and methods for emergency preparedness assessment and planning, and more particularly to a software-based platform that computes personalized emergency preparedness scores and generates prioritized preparedness plans for individual users, households, and small organizations by integrating location-specific hazard data, user-specified preparedness preferences, and critical personal dependencies, with support for multi-user and multi-location coordination, offline operation, and feedback-driven score evolution.

### BACKGROUND OF THE INVENTION

Emergency preparedness has long been recognized as a critical component of individual and community resilience. Governments, non-profit organizations, and academic institutions have developed various frameworks and tools to help individuals, households, and communities prepare for natural disasters and other emergencies. Despite this activity, existing approaches suffer from significant limitations that leave households and small organizations without effective, personalized preparedness assessment and planning tools.

### Static Checklists and Generic Guidance

Traditional emergency preparedness guidance takes the form of static checklists published by government agencies and non-profit organizations. These checklists provide generalized recommendations—such as maintaining a 72-hour supply kit, creating a family communication plan, and identifying evacuation routes—without adapting to the specific hazard profile of the user's location, the user's personal priorities, or any critical dependencies the user may have, such as reliance on powered medical equipment or refrigerated medications. While useful as baseline references, static checklists do not assess the user's current preparedness state, cannot prioritize actions based on the user's specific risk exposure, and provide no mechanism for tracking progress or updating recommendations as the user's circumstances change.

### Property-Level Hazard Scoring Systems

A class of existing systems computes hazard-related scores for individual properties, primarily in the context of real estate, insurance risk assessment, and home improvement. These systems typically ingest property characteristic data—such as structural features, age of electrical and plumbing systems, roof type, and proximity to fire hydrants—along with location-based hazard data, and apply machine learning models or weighted scoring algorithms to produce a property-level score reflecting the property's vulnerability to specific hazards. Some systems in this class further generate recommendations for property modifications (e.g., installing fire sprinklers, upgrading roofing materials) that would improve the property score. While these systems demonstrate the technical feasibility of combining location hazard data with entity-specific attributes to produce a meaningful score, they are fundamentally property-centric: they evaluate the physical characteristics of a structure rather than the preparedness posture of the people who live or work there. They do not incorporate user-specified preparedness preferences, do not model critical personal dependencies such as medical equipment requiring electricity, and do not generate household-level preparedness plans with prioritized actions that account for the occupants'actual vulnerability profile.

### Community-Level and Enterprise-Level Risk Indices

Another class of existing systems produces risk indices at the community, regional, or enterprise level. Government-sponsored risk indices, such as those that evaluate expected annual loss, social vulnerability, and community resilience across multiple natural hazard types at census-tract or county resolution, provide valuable baseline data for policy-makers and emergency managers but do not generate individualized preparedness assessments or action plans for specific households. Enterprise resilience systems assess risk across organizations using vulnerability analysis, impact assessment, and capability evaluation to produce organizational risk mitigation plans and continuous monitoring frameworks. These enterprise systems operate at a level of abstraction and organizational scope that does not translate to household or small-organization preparedness, and they do not incorporate personal preparedness preferences or critical individual dependencies.

Multi-criteria decision analysis systems applied to disaster contexts create dynamic risk indices by processing heterogeneous GIS data from multiple sources, enabling iterative updating of risk objects correlated with geographic locations. While technically sophisticated, these systems are designed for emergency responder resource prioritization—determining where to allocate response assets—rather than for assessing or improving the preparedness of individual households.

### Location-Based Alert and Safety Tracking Systems

A further class of existing systems focuses on location-based risk alerts and safety tracking. These systems calculate user-specific risk scores based on proximity to hazard events, compare those scores against user-defined risk thresholds, and generate alerts when risk levels are exceeded. Some systems in this class support group-based safety tracking, allowing users to monitor the locations and safety status of family members or team members. However, these systems are reactive rather than proactive: they respond to active hazard events rather than assessing pre-emergency preparedness. They do not compute a preparedness readiness score, do not generate preparedness improvement plans, and do not model how a user's critical dependencies affect their vulnerability during emergencies.

### Facility-Level Preparedness Tracking

Certain existing systems address preparedness at the facility level, particularly for healthcare organizations, industrial plants, and commercial buildings. These systems evaluate facility compliance against predetermined standards, track the status of preparedness recommendations (e.g., approved, trained, tested), and generate checklists tailored to specific emergency types and facility characteristics. While these systems incorporate elements of preparedness assessment, they operate at the facility level against institutional compliance standards rather than computing personalized scores for individual users or households. They do not integrate user-specified preparedness preferences, do not model critical personal dependencies, and do not support coordinated multi-location family or small-organization planning.

### Identified Limitations

Collectively, existing systems fail to address several interrelated needs:
No existing system computes a personalized emergency preparedness score for a household by integrating (a) location-specific hazard and risk data, (b) user-specified preparedness preferences indicating which hazards to emphasize and any budget, time, or priority constraints, and (c) critical personal dependencies such as powered medical equipment, refrigerated medications, mobility aids, or essential communication devices. The combination of these three input classes to produce a household-level preparedness score and associated preparedness plan represents an unaddressed gap in the prior art.
No existing system supports coordinated preparedness planning across multiple users and multiple geographic locations—such as an extended family with homes in different hazard zones, a homeowners'association coordinating across a neighborhood, or a small employer with distributed staff—with shared plans, cross-location dependency tracking, role-based access, and aggregate preparedness scoring.
Existing preparedness tools provide little or no capability for offline operation, despite the fact that emergency preparedness is precisely the context where internet connectivity is most likely to be unavailable. Approximately nine percent of disaster-related mobile applications include any form of offline functionality. No existing system enables a user to compute or update a preparedness score, view a preparedness plan, or record task completions while disconnected, with subsequent synchronization upon connectivity restoration.
Existing systems that connect scores to recommendations generally lack a closed feedback loop in which user actions—such as completing a recommended preparedness task—automatically trigger re-computation of the preparedness score and adaptive re-prioritization of the preparedness plan. While some property-scoring systems update a property score when a structural modification is implemented, this pattern has not been applied to household preparedness scoring with the three-input-class combination described above.
Existing scoring architectures in the preparedness domain are locked to specific algorithmic approaches (e.g., a particular machine learning model type or a fixed multi-criteria decision analysis framework), limiting their ability to accommodate evolving scoring methodologies without fundamental architectural change.

There is therefore a need for a personalized emergency preparedness scoring and planning platform that addresses these limitations by combining location-specific hazard data, user-specified preparedness preferences, and critical personal dependencies into a modular, algorithm-agnostic scoring architecture that supports single-household and multi-user/multi-location use, operates in offline and intermittently connected environments, and incorporates feedback-driven score and plan evolution.

### SUMMARY OF THE INVENTION

The present invention provides a computer-implemented platform for personalized emergency preparedness scoring and planning. The platform receives, for at least one user associated with at least one geographic location, three classes of input data: (1) location-specific hazard data ingested from one or more external data sources and normalized into a common representation; (2) user-specified preparedness preferences indicating which hazard types to emphasize, budget constraints, time constraints, and priority orderings among preparedness categories; and (3) critical dependency data identifying resources or conditions upon which the user depends during an emergency, such as powered medical equipment, refrigerated medications, mobility aids, and essential communication devices.

A modular scoring engine processes these three input classes to generate a composite preparedness score and a plurality of sub-scores, each sub-score corresponding to a distinct preparedness dimension (e.g., shelter-in-place readiness, evacuation readiness, supply adequacy, power continuity, communication readiness). The modular scoring engine comprises a plurality of sub-score computation units and a score aggregation unit. Each sub-score computation unit is responsible for evaluating a respective preparedness dimension using the normalized hazard data, the user's preparedness preferences, and the critical dependency data. The score aggregation unit combines the sub-scores, using the user's preparedness preferences as weighting or adjustment inputs, to produce the composite preparedness score. The scoring engine is algorithm-agnostic: individual sub-score computation units may be implemented using rule-based logic, weighted-sum calculations, trained machine learning models, or other computational approaches, and may be replaced or upgraded without modifying the overall scoring engine architecture or the aggregation function.

A planning engine receives the composite preparedness score, the sub-scores, and the user's preparedness preferences and critical dependencies, and generates a prioritized preparedness plan comprising ranked action items. Each action item is associated with a target sub-score improvement and may be constrained by the user's budget or time preferences. The planning engine accesses a sub-score-to-action mapping data structure that links each sub-score dimension to candidate action items with predicted impact ranges, estimated costs, and estimated times-to-complete.

In some embodiments, the platform supports multiple users across multiple geographic locations. A multi-location coordination manager maintains preparedness profiles and scores for each location and each user, identifies and tracks cross-location dependencies (e.g., shared resources, evacuation routes serving multiple locations, supplies stored at one location for use at another), computes aggregate preparedness scores, and generates coordinated preparedness plans that resolve inter-location conflicts and shared-resource allocation. Role-based access controls allow different users within a group to view, edit, or approve portions of the coordinated plan.

In some embodiments, the platform operates in an offline-first configuration in which a local data store on a user's device caches the user's preparedness profile, a subset of hazard data, the current score and plan state, and sufficient scoring engine logic to enable on-device score computation and plan generation when network connectivity is unavailable. A sync manager detects connectivity status, coordinates data exchange with a remote server when online, and upon connectivity restoration, synchronizes locally modified data using a conflict resolution protocol that applies domain-specific rules (e.g., remote hazard data is authoritative; user profile changes use a last-write-wins policy with user review).

In some embodiments, the platform implements a feedback loop in which the user's completion of recommended actions triggers re-computation of affected sub-scores and the composite preparedness score, and adaptive re-prioritization of the preparedness plan. A temporal score history data structure records score values over time, enabling preparedness trajectory visualization.

In some embodiments, the platform provides organizational dashboard capabilities for small employers, homeowners'associations, and community groups, including aggregate preparedness scores, compliance tracking against organizational thresholds, bulk plan assignment, and escalation workflows.

In some embodiments, the platform optionally receives inventory data (e.g., emergency supply quantities and expiration dates) and/or sensor data (e.g., from connected home devices such as smoke detectors, UPS units, or water-leak sensors) as supplemental inputs to one or more sub-score computation units. The scoring engine operates with or without inventory data and sensor data, using default assumptions or user-provided estimates when these optional data sources are absent.

As used herein, “computer-readable storage medium” and “non-transitory computer-readable medium” expressly exclude transitory propagating signals.

### BRIEF DESCRIPTION OF THE DRAWINGS

The accompanying drawings, which are incorporated in and constitute a part of this specification, illustrate embodiments of the invention and, together with the Detailed Description, serve to explain the principles of the invention.

FIG. 1 is a system-level block diagram of the personalized preparedness scoring and planning platform, showing the core modules—profile management module, hazard ingestion and normalization module, modular scoring engine (with sub-score computation units and score aggregation unit), planning engine, multi-location coordination manager, local data store and sync manager, and user interface components—and the primary data flows among these modules and between the platform and external hazard data sources, user devices, and remote servers.

FIG. 2 is a data-flow diagram illustrating the primary method for computing a personalized preparedness score and generating a preparedness plan for a single household, showing the sequential processing of user profile data (location, preferences, critical dependencies), ingestion and normalization of external hazard data, sub-score computation across multiple preparedness dimensions, composite score aggregation, gap identification, action-item mapping, plan prioritization, and presentation of the composite score, sub-scores, and prioritized plan to the user.

FIG. 3 is a method flowchart illustrating the user-action feedback loop, showing the steps of receiving a task-completion signal from the user, mapping the completed action to affected sub-score dimensions, re-computing the affected sub-scores, re-computing the composite preparedness score, re-prioritizing the preparedness plan (including introducing newly relevant actions and retiring actions no longer cost-effective), and presenting the updated score and plan to the user.

FIG. 4 is a method flowchart illustrating multi-location coordination, showing the steps of receiving preparedness profiles for multiple users across multiple geographic locations, computing per-location preparedness scores, identifying cross-location dependencies, computing an aggregate preparedness score accounting for cross-location dependency risks, generating a coordinated preparedness plan with shared and location-specific action items, resolving inter-location conflicts, and presenting per-location scores, aggregate score, and coordinated plan through a consolidated dashboard.

FIG. 5 is a method flowchart illustrating offline operation and synchronization, showing the steps of pre-caching hazard data and profile data to a local data store, detecting loss of network connectivity, computing the preparedness score using locally cached data, recording task-completion signals locally, detecting connectivity restoration, performing delta synchronization with the remote server, applying conflict resolution rules, updating the score with newly available hazard data, and annotating scores with data-freshness metadata.

FIG. 6 is a structural block diagram illustrating a single-household deployment of the platform (Embodiment A), showing the user profile data structure (with geographic location, hazard-preference vector, budget/time constraints, and critical-dependency list), the hazard data pipeline connecting to external APIs, the scoring engine processing flow (sub-score computation units and score aggregation unit), the planning engine processing flow (gap indicator mapping, action-item filtering, plan ranking), and the user interface presenting the composite score, sub-scores, and preparedness plan.

FIG. 7 is a structural block diagram illustrating a multi-home extended-family deployment (Embodiment B), showing a group data structure associating multiple user profiles with a group identifier, per-location hazard vectors and scores, a cross-location dependency graph with shared resource links, the aggregate scoring module, the coordinated plan generator, and role-based access control data structures.

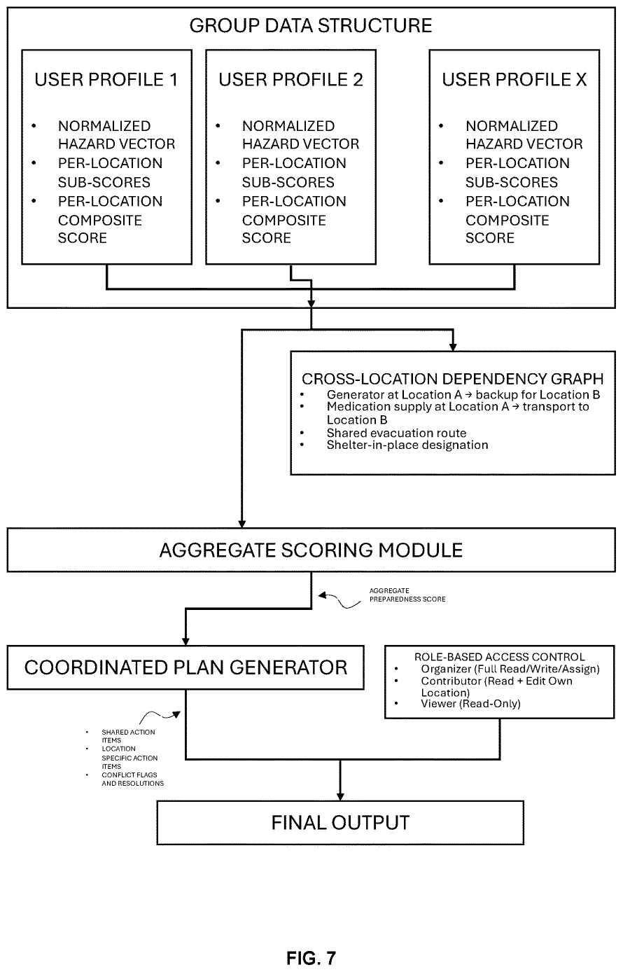

FIG. 8 is a structural block diagram illustrating a small-organization dashboard deployment (Embodiment F), showing the organization profile data structure, the administrative dashboard with aggregate preparedness scores, the bulk plan assignment module, the compliance reporting module with configurable escalation workflows, and connections to the underlying modular scoring engine and planning engine serving both individual member views and aggregate organization views.

FIG. 9 is a detailed architectural diagram of the modular scoring engine (Embodiment E), showing the sub-score interface specification defining input contracts (normalized hazard vector, user profile, dependency data) and output contracts (numeric sub-score, contributing-factor breakdown), the model registry storing multiple versioned sub-score computation implementations (rule-based, weighted-sum, trained ML model), the configuration mechanism for runtime model selection and hot-swapping, the score-decomposition output format, and the model versioning and audit trail data structure.

FIG. 10 is a user interface mockup illustrating a score and sub-score dashboard with drill-down capability, showing a composite preparedness score displayed prominently with a numeric value and visual gauge, a set of sub-score indicators (e.g., shelter readiness, evacuation readiness, supply adequacy, power continuity, communication readiness) arranged as selectable elements, and a drill-down panel showing, for a selected sub-score, its contributing factors, the underlying hazard data values, the critical dependencies affecting the score, and recommended actions associated with that sub-score dimension.

FIG. 11 is a user interface mockup illustrating a preparedness trajectory visualization over time, showing a time-series plot of the composite preparedness score and individual sub-scores on the vertical axis and chronological time on the horizontal axis, with event markers indicating task-completion events (e.g., “purchased generator,” “completed evacuation drill”) and hazard-data-change events (e.g., “wildfire risk zone updated”) positioned on the timeline, enabling the user to correlate specific actions and external changes with score improvements or decrements.

FIG. 12 is a user interface mockup illustrating a multi-location comparison view, showing a side-by-side or card-based layout displaying per-location composite scores and sub-score summaries for two or more geographic locations associated with a user group, with visual indicators (e.g., connecting lines, shared-resource icons) denoting cross-location dependencies, and highlighting locations where a dependency at one location affects the score at another location.

### DETAILED DESCRIPTION OF THE PREFERRED EMBODIMENTS

The following Detailed Description refers to the accompanying drawings and describes various embodiments of the invention. The embodiments described herein are illustrative and are not intended to limit the scope of the invention. Those skilled in the art will appreciate that various modifications and equivalents may be made without departing from the spirit of the invention. Throughout this description, like reference numerals refer to like elements across different figures.

### System Overview

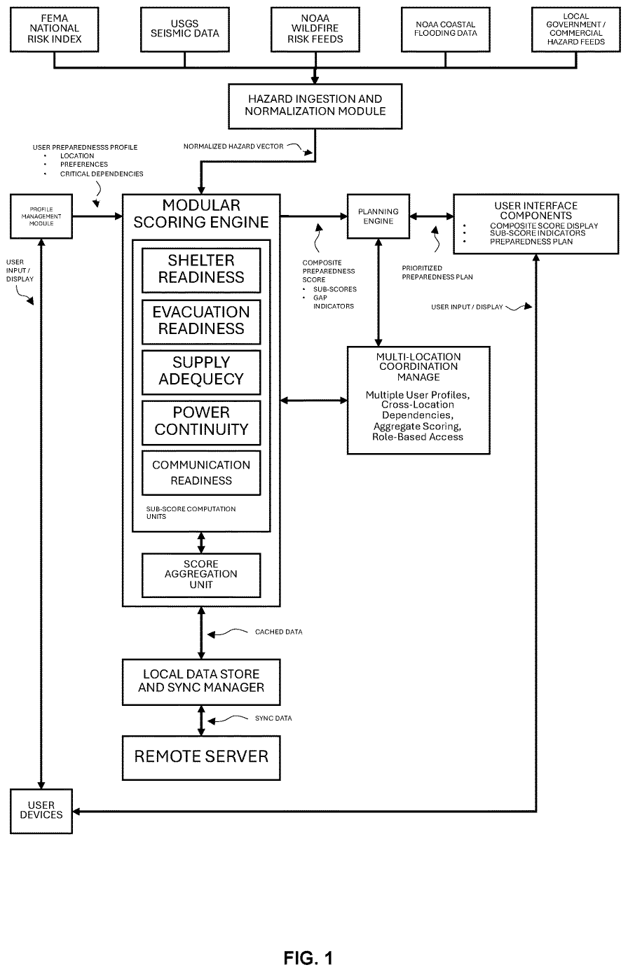

Referring now to FIG. 1, the personalized preparedness scoring and planning platform (hereinafter “platform” or “system”) comprises several interoperating modules implemented by one or more processors executing instructions stored in one or more non-transitory computer-readable storage media. The platform may be deployed as a cloud-hosted service, a client-side application, or a hybrid of both, depending on the embodiment. The core modules of the platform include:
Profile Management Module. The profile management module is configured to receive and store, for at least one user, a preparedness profile comprising (a) geographic location data identifying one or more locations associated with the user (e.g., home address, workplace address, secondary residence), (b) user-specified preparedness preferences indicating which hazard types to emphasize, budget constraints, time constraints, and a user-defined prioritization among a plurality of preparedness categories, and (c) critical dependency data identifying resources or conditions upon which the user depends during an emergency. Critical dependencies may include, without limitation, powered medical equipment (e.g., CPAP machines, oxygen concentrators, dialysis equipment), refrigerated medications (e.g., insulin), mobility aids (e.g., wheelchairs, walkers), essential communication devices, and specific power-supply requirements. In some embodiments, critical dependencies are selected from the group consisting of medical needs, assistive-device requirements, mobility constraints, and power-supply requirements. The profile management module stores profile data in a structured data format (e.g., JSON documents, relational database records) and supports creation, retrieval, update, and deletion of profile records. In some embodiments, the profile management module supports multiple user profiles associated with a single household or group.
Hazard Ingestion and Normalization Module. The hazard ingestion and normalization module is configured to receive location-specific hazard data from one or more external hazard data sources for each geographic location in the user's preparedness profile. External hazard data sources may include, without limitation, the FEMA National Risk Index (which provides hazard data covering eighteen natural hazard types at census-tract resolution), USGS seismic hazard data, NOAA wildfire risk feeds, NOAA coastal flooding data, local government hazard assessment feeds, and commercial hazard data providers. The hazard ingestion and normalization module implements a multi-step data processing pipeline comprising: (i) parsing heterogeneous data formats received from different external sources (e.g., JSON, GeoJSON, raster data, CSV); (ii) unit conversion to standardize measurement units across sources; (iii) spatial alignment to map hazard data to the geographic coordinates or census-tract identifiers associated with the user's locations; (iv) temporal alignment to account for data freshness and reporting periods across different sources; and (v) scale normalization to transform hazard severity values from different sources into a common, comparable scale, producing a normalized hazard vector for each user location. In some embodiments, the module implements delta-based hazard data refresh, identifying and retrieving only changed data elements since the last synchronization timestamp, thereby reducing bandwidth and processing overhead. In some embodiments, the module implements cross-source hazard data validation, cross-referencing hazard indicators from multiple sources and flagging discrepancies to improve data quality.
Modular Scoring Engine. The modular scoring engine is the central computational component of the platform. It comprises a plurality of sub-score computation units and a score aggregation unit. Each sub-score computation unit is configured to receive a defined set of inputs—comprising at least a portion of the normalized hazard vector, the user's preparedness preferences, and the critical dependency data—and to produce a numeric sub-score corresponding to a specific preparedness dimension, along with a contributing-factor breakdown that identifies the data elements and conditions that most significantly influenced the sub-score value. Representative preparedness dimensions include, without limitation, shelter-in-place readiness, evacuation readiness, supply adequacy, power continuity, and communication readiness. The score aggregation unit applies an aggregation function to the plurality of sub-scores, using the user's preparedness preferences as weighting or adjustment inputs, to produce a composite preparedness score. The modular scoring engine exposes a sub-score interface specification that defines the input contract and output contract for each sub-score computation unit, enabling sub-score computation units to be independently developed, tested, deployed, and replaced without affecting other sub-score computation units or the aggregation function. A model registry stores available sub-score computation implementations with associated version identifiers, and a configuration mechanism selects which implementation to use for each sub-score dimension at runtime.
Planning Engine. The planning engine is configured to receive the composite preparedness score, the plurality of sub-scores, gap indicators identifying preparedness deficiencies, the user's preparedness preferences, and the critical dependency data, and to generate a prioritized preparedness plan comprising ranked action items. The planning engine accesses a sub-score-to-action mapping data structure that links each sub-score dimension to a set of candidate action items, where each candidate action item has attributes including a predicted sub-score impact range (the estimated improvement to the relevant sub-score if the action is completed), an estimated cost, and an estimated time-to-complete. The planning engine maps each gap indicator to one or more candidate action items, filters and prioritizes the candidates based on the user's budget and time constraints and the relative deficits of the associated sub-scores from target sub-score thresholds, and outputs a ranked preparedness plan. In some embodiments, the planning engine implements adaptive re-prioritization: when hazard data changes significantly or when the user completes one or more action items, the planning engine re-generates the ranked plan, potentially introducing newly relevant actions or retiring actions that are no longer cost-effective given the user's updated preparedness state.
Multi-Location Coordination Manager. In embodiments supporting multiple users and/or multiple geographic locations, a multi-location coordination manager maintains preparedness profiles and scores for a plurality of locations and a plurality of users. The coordination manager identifies and tracks cross-location dependencies (e.g., a generator at Location A designated as a backup for a user with powered medical equipment at Location B; a medication supply at one location intended for transport to another in an evacuation; an evacuation route shared by occupants of multiple locations). The coordination manager computes an aggregate preparedness score across locations, accounting for cross-location dependency risks, and generates a coordinated preparedness plan that identifies shared action items and location-specific action items, flags conflicts (e.g., two locations both relying on the same limited resource), and suggests resolutions. The multi-location coordination manager supports role-based access and permissions, allowing different users within a group to be assigned roles (e.g., organizer, contributor, viewer) that control which portions of the coordinated plan each user may view or edit.
Local Data Store and Sync Manager. In embodiments supporting offline operation, the platform includes a local data store on the user's device (e.g., an embedded database such as SQLite) that caches the user's preparedness profile, a subset of hazard data, the current score and plan state, the action-item catalog, and sufficient scoring engine logic to enable on-device score computation. A sync manager detects network state changes and coordinates data exchange between the local data store and a remote server. When the device is online, the sync manager fetches the latest hazard data and pushes locally recorded changes to the remote server. When the device is offline, the scoring engine and planning engine operate against the local data store. Upon connectivity restoration, the sync manager synchronizes local changes with the remote server using a conflict resolution protocol.
User Interface Components. The platform includes one or more user interface components configured to present the composite preparedness score, sub-scores, and prioritized preparedness plan to the user. The user interface components may be implemented as native mobile applications, web applications, or both. Specific user interface features are described in further detail below. In some embodiments, the user interface includes a score-decomposition drill-down interface, a preparedness trajectory timeline, and a multi-location comparative dashboard. The user interface components maintain user interface state (display preferences, navigation state) independently from scoring engine state (current scores, model versions, computation logs), enabling the scoring engine to operate headlessly in backend or embedded contexts without coupling to any specific UI framework.

The platform's architecture separates the scoring engine state from the user interface state, enabling the scoring engine to be deployed and operated in backend-only, embedded, or client-heavy configurations without requiring modification to the scoring logic. This separation also enables the scoring engine to serve both individual user views and organizational aggregate views through the same computational infrastructure.

### Primary Data-Flow Method for Single-Household Scoring

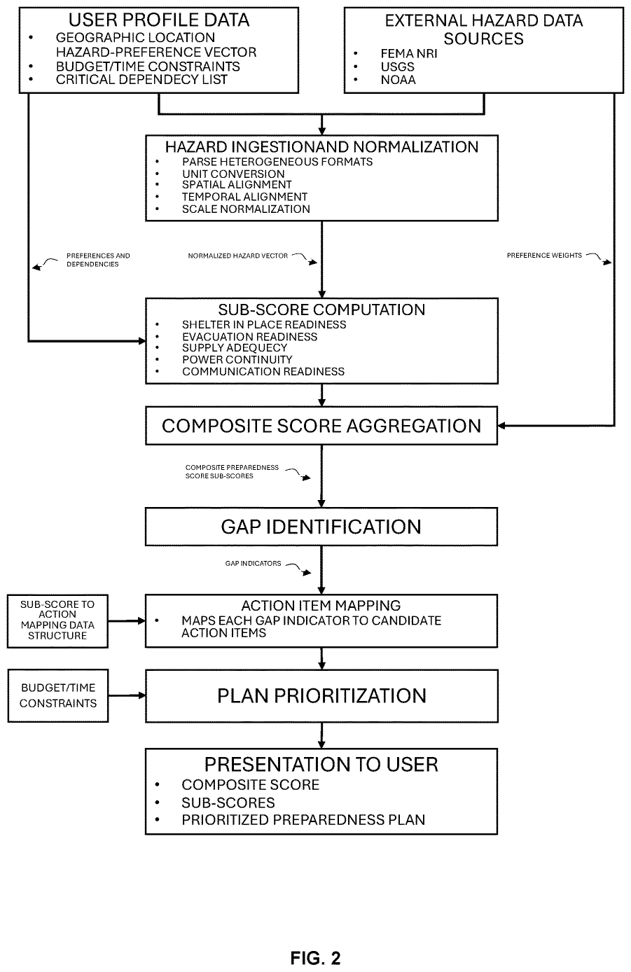

Referring now to FIG. 2, the primary method for computing a personalized preparedness score and generating a preparedness plan for a single household is illustrated as a data-flow diagram showing the sequential processing of user profile data (location, preferences, critical dependencies), ingestion and normalization of external hazard data, sub-score computation across multiple preparedness dimensions, composite score aggregation, gap identification, action-item mapping, plan prioritization, and presentation of the composite score, sub-scores, and prioritized plan to the user.
User Profile Data Structure. The profile management module stores a user profile data structure containing: geographic coordinates or a street address identifying the user's location; a hazard-preference vector comprising a mapping of hazard types (e.g., earthquake, wildfire, flood, hurricane, tornado, extreme heat) to user-assigned importance weights reflecting which hazards the user considers most relevant to their preparedness planning; budget constraint values specifying the maximum expenditure the user is willing to allocate to preparedness actions over a defined period; time constraint values specifying the time the user is willing to dedicate to preparedness actions; and a critical-dependency list in which each entry specifies a dependency type (e.g., powered medical equipment, refrigerated medication, mobility aid), its power or environmental requirement (e.g., continuous AC power, temperature below 46° F.), and a criticality ranking indicating the relative importance of each dependency.
Hazard Data Pipeline. The hazard ingestion and normalization module queries one or more external APIs to retrieve hazard data for the user's geographic location. For example, the module may query the FEMA National Risk Index API to obtain expected annual loss values and community risk factors for the user's census tract across eighteen natural hazard types; the USGS seismic hazard data service to obtain peak ground acceleration probabilities for the user's coordinates; and NOAA wildfire risk feeds to obtain current and historical wildfire risk assessments. The module transforms the heterogeneous data received from these sources through the multi-step normalization pipeline described above, producing a normalized hazard vector in which each element represents a hazard type's severity on a common scale (e.g., 0 -100 or 0-1).
Scoring Engine Processing Flow. The modular scoring engine processes the normalized hazard vector, the user profile data, and the critical dependency data through the following steps: (1) For each preparedness dimension (e.g., shelter-in-place readiness, evacuation readiness, supply sufficiency, power continuity, communication readiness), a sub-score computation unit evaluates the user's current preparedness state against the normalized hazard indicators and the critical dependency requirements. For example, the power-continuity sub-score computation unit may evaluate whether the user has backup power capability in light of the user's declared critical dependencies that require electricity, the likelihood and duration of power outages indicated by the hazard data for the user's location, and the user's stated priority weighting for power-related preparedness. (2) The score aggregation unit applies the user's preference weights from the hazard-preference vector to the sub-scores and computes a composite preparedness score. (3) The scoring engine outputs the composite score, the vector of sub-scores, and a set of gap indicators identifying where the largest deficiencies exist (i.e., sub-scores furthest below their respective target thresholds).
Planning Engine Processing Flow. The planning engine receives the gap indicators and processes them as follows: (1) The engine maps each gap indicator to one or more candidate action items from the sub-score-to-action mapping data structure. For example, a gap indicator for the power-continuity dimension may map to candidate actions such as “purchase portable generator,” “install whole-house transfer switch,” or “acquire portable battery pack rated for medical equipment.” (2) The engine filters and prioritizes the candidate actions based on the user's budget and time constraints, the predicted sub-score impact of each action, and the relative deficit of the associated sub-score from its target threshold. (3) The engine outputs a ranked preparedness plan in which actions expected to produce the greatest improvement in the most deficient sub-score dimensions, within the user's constraints, appear first.

### Feedback-Loop-Driven Plan Evolution

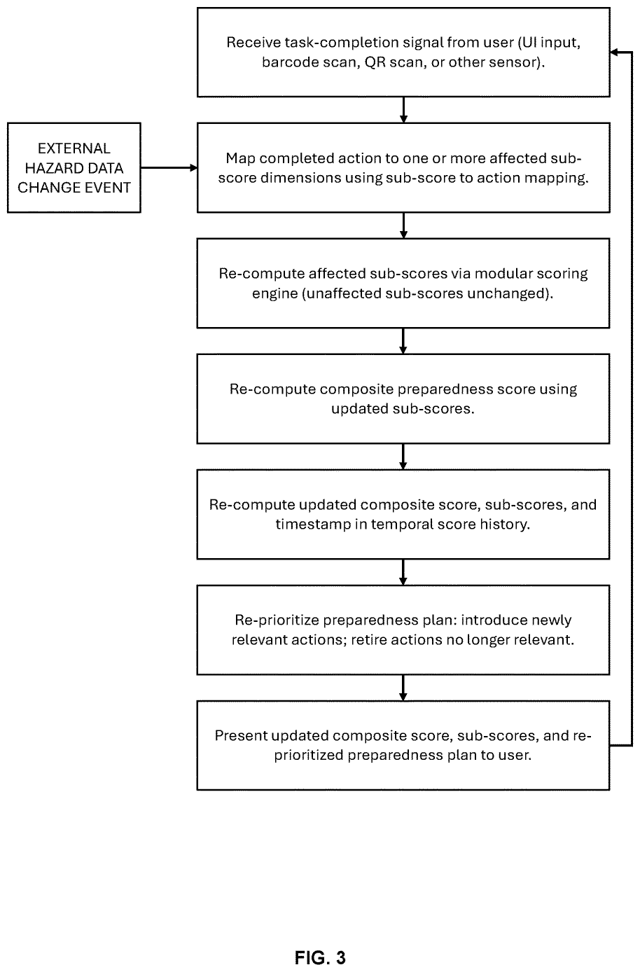

Referring now to FIG. 3, the platform implements a closed feedback loop in which user actions—specifically, the completion of recommended preparedness tasks—automatically trigger re-computation of affected sub-scores and the composite preparedness score, and adaptive re-prioritization of the preparedness plan. This embodiment is a cross-cutting capability applicable to all user scales (single household, multi-location family, organization).
Task-Completion Tracking Module. The platform includes a task-completion tracking module that receives completion signals indicating that the user has completed one or more action items from the preparedness plan. Completion signals may be received through: direct user input via the user interface (e.g., the user taps a “mark complete” button adjacent to an action item); barcode or QR code scanning of purchased supplies (e.g., scanning a receipt or product barcode to confirm acquisition of recommended items); or, in embodiments that include optional sensor integrations, sensor data from connected devices confirming an operational state change (e.g., a uninterrupted power supply unit reporting that it is online and at full charge).
Score Re-Computation Pipeline. Upon receiving a task-completion signal, the score re-computation pipeline: (i) maps the completed action item to the one or more sub-score dimensions that the action affects, using the sub-score-to-action mapping data structure; (ii) re-evaluates the affected sub-scores using the same modular scoring engine pipeline described in FIG. 1 and FIG. 2, but with the user's preparedness state updated to reflect the completed action; (iii) re-computes the composite preparedness score using the updated sub-scores; and (iv) provides the updated scores to the planning engine for plan re-prioritization. Sub-scores corresponding to unaffected preparedness dimensions remain unchanged, providing computational efficiency.
Adaptive Plan Adjustment. Upon re-prioritization, the planning engine may introduce new action items that were not previously surfaced—because the user's changed preparedness state now makes those actions relevant or cost-effective—or may retire action items that are no longer beneficial given the user's improved score in certain dimensions. For example, if the user has completed all recommended actions for the power-continuity dimension, the planning engine may now surface actions for the evacuation-readiness dimension that were previously lower-priority.
External-Event-Driven Score Updates. In some embodiments, the feedback loop is bidirectional: in addition to user-initiated task completions, the platform also triggers score re-computation and plan re-prioritization in response to changes in external hazard data. For example, if the hazard ingestion module detects that a user's location has been newly designated within a wildfire risk zone, the platform automatically re-computes the relevant sub-scores and updates the preparedness plan to reflect the changed risk environment, pushing updated recommendations to the user through a notification subsystem.

This feedback-loop-driven plan evolution is structurally distinct from facility-level preparedness tracking systems in the prior art, which monitor the progress of facility recommendations against predetermined compliance standards but do not re-compute a personalized preparedness score based on completed actions or adaptively re-prioritize a preparedness plan driven by three-input-class scoring. It is also distinct from property-scoring systems that update a home score after a structural modification, because the present embodiment operates on preparedness actions and critical dependencies rather than property attributes.

### Multi-Location Coordination Method

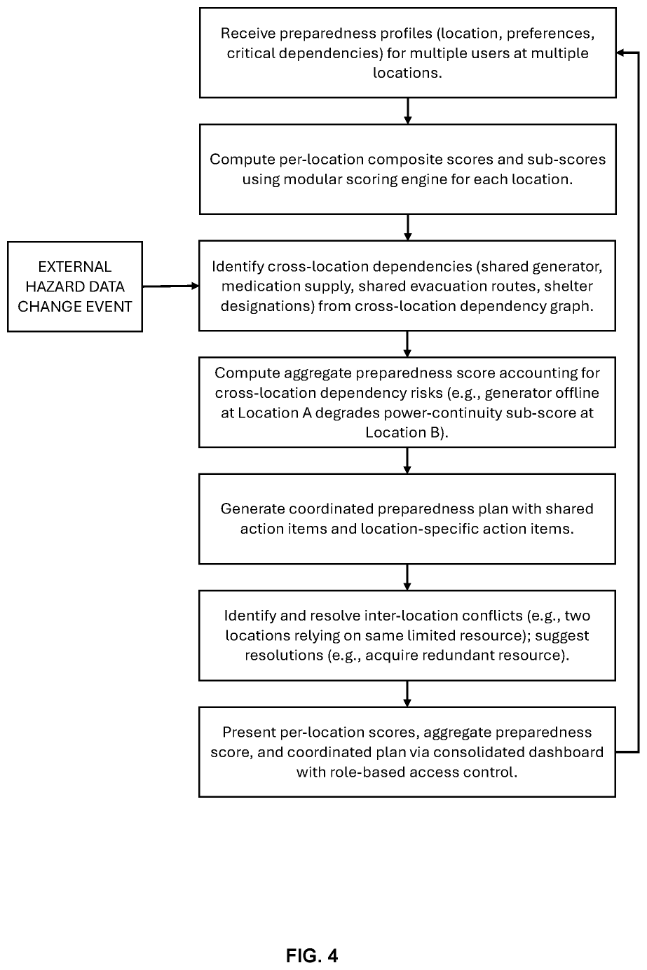

Referring now to FIG. 4, in embodiments supporting multiple users associated with multiple geographic locations—for example, an extended family with homes in different regions (e.g., Portland, Oregon and Phoenix, Arizona), or a group of related households coordinating their preparedness efforts—the platform implements a multi-location coordination method. FIG. 4 illustrates the steps of receiving preparedness profiles for multiple users, computing per-location scores, identifying cross-location dependencies, computing an aggregate preparedness score, and generating a coordinated plan.
Group Data Structure. The platform maintains a group data structure that associates a set of user profiles with a group identifier. Each user within the group is linked to one or more geographic locations. Each location has its own normalized hazard vector, per-location preparedness profile data (including location-specific preferences and dependencies), and per-location preparedness scores computed as described in FIGS. 1-3.
Cross-Location Dependency Graph. The multi-location coordination manager maintains a cross-location dependency graph that identifies shared resources and cross-location relationships. Entries in the dependency graph may include: an emergency generator stored at Location A that is designated as a backup power source for a family member with powered medical equipment at Location B; a medication supply stored at Location A that must be transported to Location B in an evacuation scenario; an evacuation route that is shared by occupants of both locations; a shelter-in-place location designated to receive occupants of another location if that location becomes uninhabitable. Each dependency entry specifies the resource or capability, the source location, the dependent location(s), and the conditions under which the dependency is activated (e.g., power outage at the dependent location, evacuation order at the source location).
Aggregate Scoring. The aggregate scoring module computes a group-level preparedness score by: (a) computing per-location preparedness scores using the scoring engine processing flow described in FIGS. 1-3; (b) identifying cross-location dependency risks—for example, if the generator at Location A is offline or unavailable, the power-continuity sub-score at Location B degrades because Location B's backup power plan depends on that generator; and (c) combining per-location scores into a weighted aggregate, where weights may reflect occupancy patterns (e.g., a location where family members spend most of their time receives higher weight), user-defined importance values, or the number of occupants at each location.
Coordinated Plan Generation. The coordinated plan generator produces a preparedness plan that includes both location-specific action items and shared action items. Shared action items are those that affect multiple locations (e.g., “ensure generator at Location A is serviced and operational” benefits both Location A and Location B through the cross-location dependency). The plan generator flags conflicts—such as two locations both relying on the same limited resource without sufficient redundancy—and suggests resolutions (e.g., “acquire a second portable generator to eliminate single-point-of-failure dependency”).
Role-Based Access Control. The group data structure includes role-based access control data defining roles (e.g., “organizer” with full read/write/assign authority, “contributor” with read and edit authority for their own location's plan, “viewer” with read-only access) and associating each user within the group with a role. The platform enforces these access controls when users attempt to view, edit, or approve portions of the coordinated plan.

The Multi-Location Coordination method outlined here is structurally distinct from enterprise resilience systems in the prior art, which address organizational risk mitigation at the enterprise level without household-level preparedness scoring, individual user preferences, or critical personal dependency modeling. No identified prior art system models cross-household dependency graphs for emergency preparedness coordination.

### Offline-First Operation With Synchronization

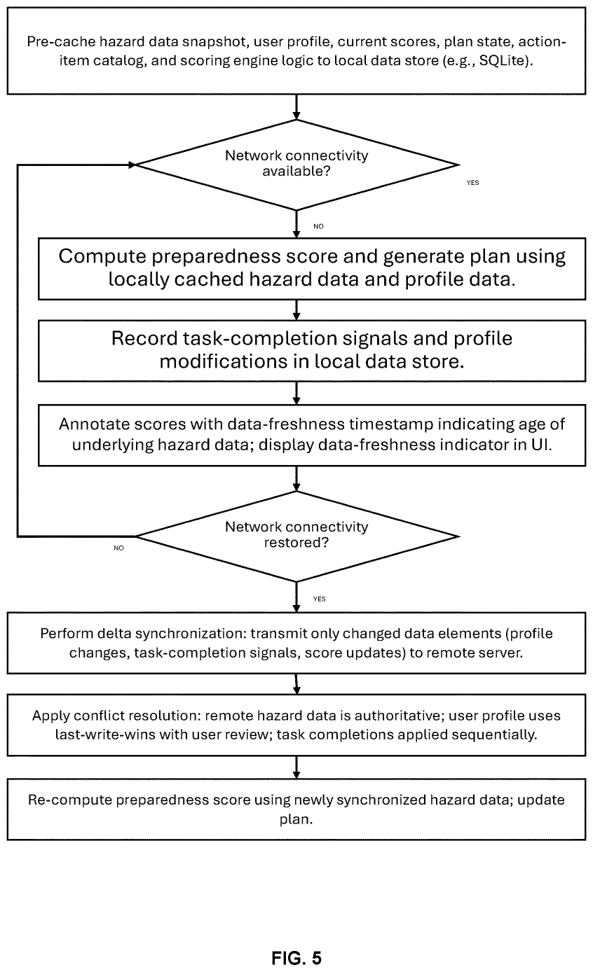

Referring now to FIG. 5, the platform is configured for offline-first operation, enabling users to access preparedness scores, view and interact with preparedness plans, and record task completions even when network connectivity is unavailable. This platform addresses the critical need for preparedness tools that function during the connectivity disruptions that commonly accompany emergencies. This is a cross-cutting capability applicable to single-household and multi-location configurations.
On-Device Data Store. The local data store resides on the user's device and may be implemented using an embedded database such as SQLite or a similar lightweight database engine suitable for mobile platforms. The local data store is pre-loaded (when the device has network connectivity) with: the user's complete preparedness profile; the most recent hazard data snapshot for all locations associated with the user; the current composite score, sub-scores, and gap indicators; the current preparedness plan including all ranked action items; and the action-item catalog sufficient to support plan generation and re-prioritization on-device. In some embodiments, the local data store also caches the scoring engine logic (e.g., sub-score computation unit implementations and aggregation function parameters) sufficient to enable on-device score computation.
Connectivity-Aware Scoring Pipeline. The platform implements a connectivity-aware scoring pipeline that: (i) detects network state changes (e.g., via operating system network status APIs); (ii) when online, fetches the latest hazard data from external sources and pushes any locally recorded changes (including task-completion signals and profile modifications) to the remote server; (iii) when offline, serves all scoring and planning functions from the local data store, using the cached hazard data snapshot and profile data; and (iv) annotates scores computed while offline with a data-freshness timestamp indicating the age of the underlying hazard data. This annotation is presented to the user through the user interface so that the user understands whether the displayed score reflects current hazard data or is based on cached information.
Conflict Resolution Protocol. Upon connectivity restoration, the sync manager compares local and remote data state versions using vector timestamps or similar versioning mechanisms. The conflict resolution protocol applies domain-specific rules: for hazard data updates, the remote server's data is treated as authoritative because external hazard data sources are maintained server-side; for user profile changes made offline, a last-write-wins policy applies, with the option for user review of conflicts when the same profile field has been modified both locally and remotely; for task-completion signals recorded offline, the system applies them sequentially (in the order they were recorded locally) and triggers re-computation of affected sub-scores and the composite score upon synchronization.
Delta-Sync Mechanism. To minimize bandwidth usage in intermittent-connectivity environments, the sync manager transmits only changed data elements (deltas) rather than full data snapshots. The delta-sync mechanism tracks changes to profile data, plan state, task-completion signals, and score values since the last successful synchronization, and packages only those changes for transmission.
Data-Freshness UI Indicator. The user interface displays a connectivity status indicator and a data-freshness indicator, making it transparent to the user whether the device is currently online or offline and whether the displayed score and plan are based on the most recent hazard data or on a cached snapshot of a known age.
Selective Pre-Caching. In some embodiments, the hazard ingestion module determines which geographic regions and hazard types to pre-cache on the device based on the user's profile locations and, optionally, declared travel patterns. This selective pre-caching optimizes local storage usage by caching hazard data most likely to be relevant to the user rather than all available hazard data.

This Offline-First Operation with Synchronization is structurally distinct from generic offline-first application architecture patents, which address bidirectional synchronization for general-purpose application data but do not address the domain-specific challenges of hazard data freshness management, preparedness score computation under stale data conditions, or preparedness plan-state reconciliation in the context of emergency preparedness.

### Embodiment A: Single-Household Preparedness Engine With Preference-Weighted Scoring

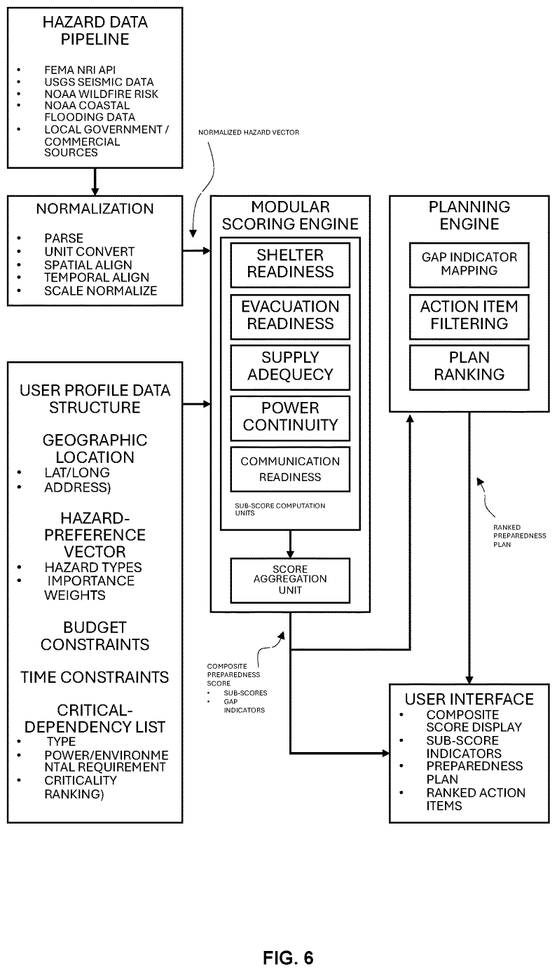

Referring now to FIG. 6, in one embodiment (Embodiment A), the platform is deployed for a single household. FIG. 6 is a structural block diagram illustrating the single-household deployment, showing the user profile data structure (with geographic location, hazard-preference vector, budget/time constraints, and critical-dependency list), the hazard data pipeline connecting to external APIs, the scoring engine processing flow (sub-score computation units and score aggregation unit), the planning engine processing flow (gap indicator mapping, action-item filtering, plan ranking), and the user interface presenting the composite score, sub-scores, and preparedness plan.

In Embodiment A, the user profile, hazard data pipeline, scoring engine processing flow, and planning engine processing flow operate as described above in connection with FIG. 2. The user interface presents the composite preparedness score, the sub-scores, and the ranked preparedness plan. In some embodiments, the user interface implements a score-decomposition drill-down interface allowing the user to select any sub-score to view its contributing factors and associated recommended actions, as described in further detail in the User Interface Details section below.

Embodiment A is structurally distinct from property-centric home scoring systems in the prior art, which evaluate physical property characteristics for insurance or structural risk purposes without incorporating user-specified preparedness preferences or critical personal dependencies. Embodiment A is also distinct from GIS-based disaster risk index systems designed for emergency responder resource prioritization, which do not generate household-level action plans.

### Embodiment B: Multi-Home or Organization Dashboard With Aggregate Reporting

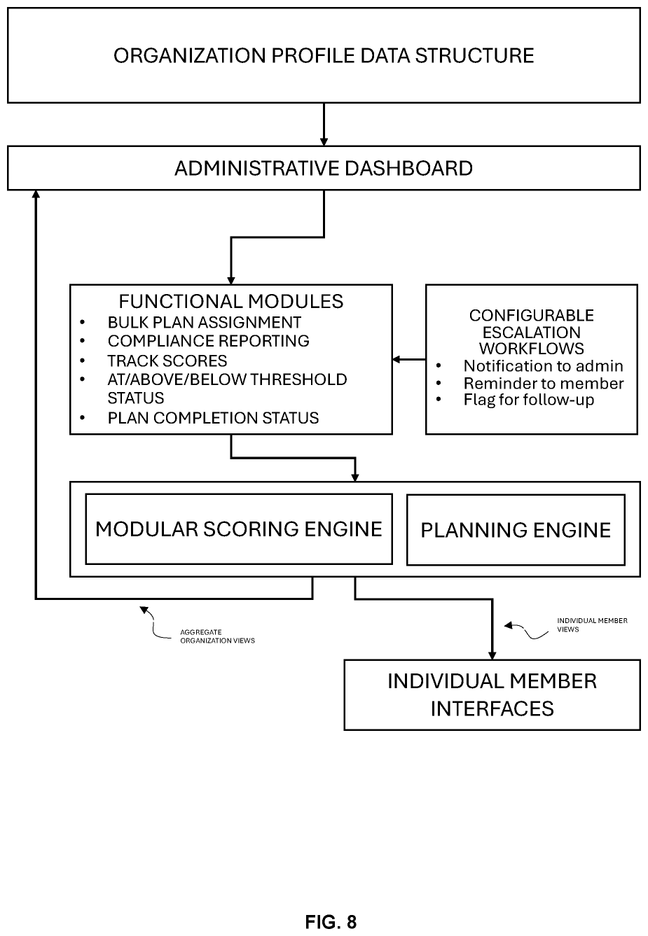

Referring now to FIG. 8, in another embodiment (Embodiment B), the platform provides a multiple home or multiple location organizational-level dashboard and management capabilities suitable for extended families, small employers, homeowners'associations, community groups, faith organizations, and similar entities that coordinate preparedness efforts across multiple members and locations. Each of these end-users is considered an organization with members for the purposes of this embodiment.
Multi-home or Organization Profile Data Structure. The organization profile data structure includes metadata (e.g., organization name, type, jurisdiction, organizational preparedness policies), compliance thresholds specifying minimum acceptable preparedness scores for members, and administrative configuration parameters.
Administrative Dashboard. The platform presents an administrative dashboard to authorized administrators of the organization. The dashboard displays aggregate preparedness scores across all members and locations, including: the distribution of composite preparedness scores across all members (e.g., histogram or percentile breakdown); identification of the lowest-scoring locations or members requiring attention; aggregate dependency vulnerability statistics (e.g., “15 of 30 members have no backup power source for medical equipment,” “8 of 30 members in wildfire zone have not completed evacuation route planning”); plan completion rates across the organization; and trend data showing organizational preparedness improvement over time.
Bulk Plan Assignment Module. An administrator may use the bulk plan assignment module to push standardized action items to all members or to a filtered subset of members (e.g., all members located within a particular wildfire zone, all members with identified power-dependency vulnerabilities). Standardized action items pushed by the administrator appear in each targeted member's individual preparedness plan alongside their personalized action items. Individual members retain the ability to customize their own plans within organizational constraints (e.g., they cannot remove organization-mandated action items but can add personal action items and adjust priorities among non-mandated items).
Compliance Reporting Module. The compliance reporting module tracks whether each member's composite preparedness score and relevant sub-scores meet the organizational compliance thresholds defined in the organization profile. The module generates compliance reports showing members at, above, or below threshold; time-since-last-score-update for each member; and plan completion status. In some embodiments, the module supports configurable escalation workflows—for example, if a member's score falls below the compliance threshold for a defined period, the system may generate a notification to the administrator, send a reminder to the member, or flag the member for follow-up in the administrative dashboard.

Embodiment B structurally distinct from enterprise resilience systems in the prior art, which focus on enterprise-level risk diagnosis and mitigation planning at an organizational abstraction level without individual household preparedness scoring, user-specified preferences, or critical personal dependency modeling. Embodiment B is also distinct from compliance tracking systems that track facility-level compliance using status indicators (e.g., approved, trained, tested) without computing personalized preparedness scores or generating actionable plans based on hazard data and personal dependencies.

### Embodiment C: Algorithm-Agnostic Modular Scoring Engine With Pluggable Models

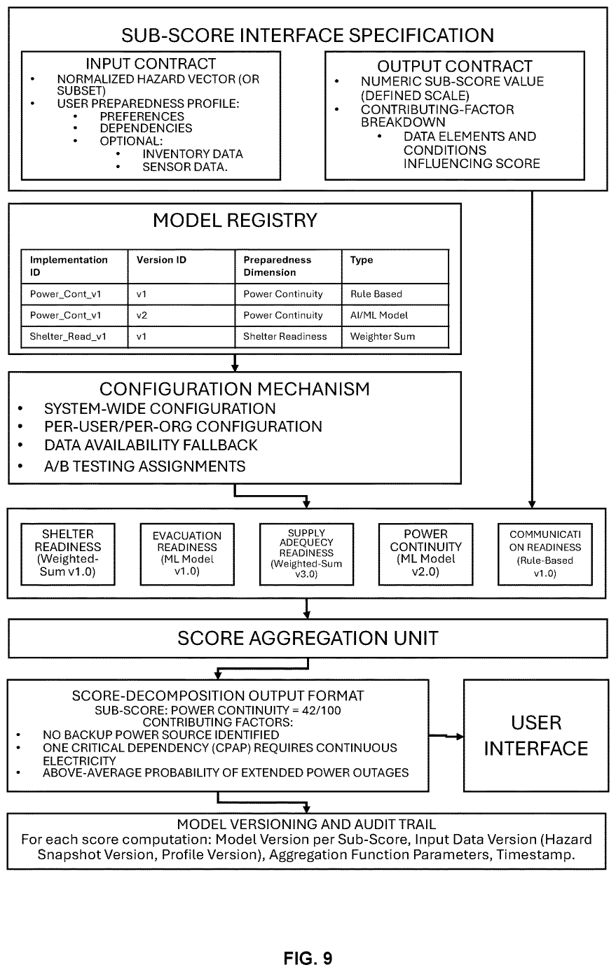

Referring now to FIG. 9, in another embodiment (Embodiment C), the modular scoring engine is described in detail as a cross-cutting architecture underlying all user-facing embodiments. This embodiment addresses the need for a scoring engine that can accommodate evolving scoring methodologies without requiring architectural replacement or claim-scope narrowing.
Sub-Score Interface Specification. The modular scoring engine defines a sub-score interface specification comprising: (a) an input contract specifying that each sub-score computation unit receives a normalized hazard vector (or a relevant subset thereof), the user's preparedness profile (including preferences and dependency data), and optionally supplemental data (e.g., inventory data, sensor data); and (b) an output contract specifying that each sub-score computation unit produces a numeric sub-score value on a defined scale, along with a contributing-factor breakdown that identifies the specific input data elements and conditions that most significantly influenced the computed sub-score value. This interface specification enables sub-score computation units to be developed, tested, and deployed independently, provided they conform to the defined input and output contracts.
Model Registry. A model registry stores available sub-score computation implementations, each associated with a unique version identifier, a set of input-parameter specifications describing which data fields the implementation requires, and metadata describing the implementation type (e.g., rule-based, weighted-sum, trained machine learning model, ensemble model). The model registry may store multiple implementations for the same preparedness dimension—for example, a rule-based implementation and a machine-learning-based implementation for the power-continuity sub-score—enabling the platform to select among them based on configuration, administrative policy, or experimental conditions.
Runtime Configuration and Model Selection. A configuration mechanism selects which sub-score computation implementation to use for each preparedness dimension at runtime. This selection may be driven by: system-wide configuration set by a platform administrator; per-user or per-organization configuration specifying a preferred scoring approach; availability of input data (e.g., if a machine-learning-based implementation requires sensor data that is not available for a particular user, the system falls back to a rule-based implementation); or A/B testing assignments in which different users are assigned to different model versions for comparative analysis of scoring accuracy and user outcomes.
Model Versioning and Audit Trail. The platform maintains a model versioning and audit trail data structure that records, for each historical score computation, the specific model version used for each sub-score, the version of the input data (hazard data snapshot version, profile data version), and the aggregation function parameters used. This audit trail enables reproducibility of past score computations and supports regulatory defensibility in contexts where preparedness scoring may be used for compliance or reporting purposes.
Score-Decomposition Output Format. For each sub-score, the scoring engine produces not only the numeric value but also a human-readable contributing-factor breakdown. For example, for a power-continuity sub-score of 42 out of 100, the breakdown might indicate: “no backup power source identified,” “one critical dependency (CPAP machine) requires continuous electricity,” and “location hazard data indicates above-average probability of extended power outages.” This decomposition is passed to the user interface for presentation in the drill-down view described in the User Interface Details section below.
Pluggable Model Update Pipeline. The platform supports a pluggable model update pipeline that allows new sub-score computation implementations to be deployed without altering the scoring engine's core architecture or the user's profile data. For SaaS (cloud-hosted) deployments, new model implementations may be deployed server-side and activated through the model registry without requiring any client-side update. For client-heavy (offline-first) deployments, new model implementations may be distributed via application updates, with the model registry on the device updated accordingly upon installation.

This embodiment is structurally distinct from scoring engines in the prior art that are locked to a specific algorithmic framework. Systems that define scoring in terms of a specific multi-criteria decision analysis framework with fixed object types are constrained to that analytical paradigm. Systems that require a “trained machine learning evaluation model” as an integral claim element are constrained to machine-learning-based approaches. The present embodiment provides a meta-architecture that accommodates rule-based, statistical, machine-learning-based, and hybrid scoring approaches interchangeably, ensuring that the platform can evolve its scoring methodology as the field advances without requiring replacement of the underlying system architecture.

### User Interface Details

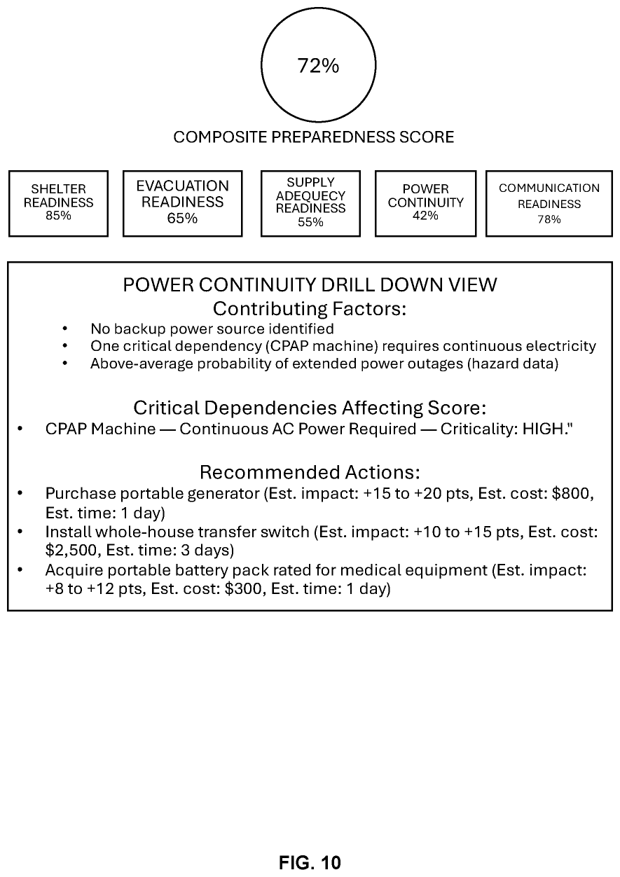

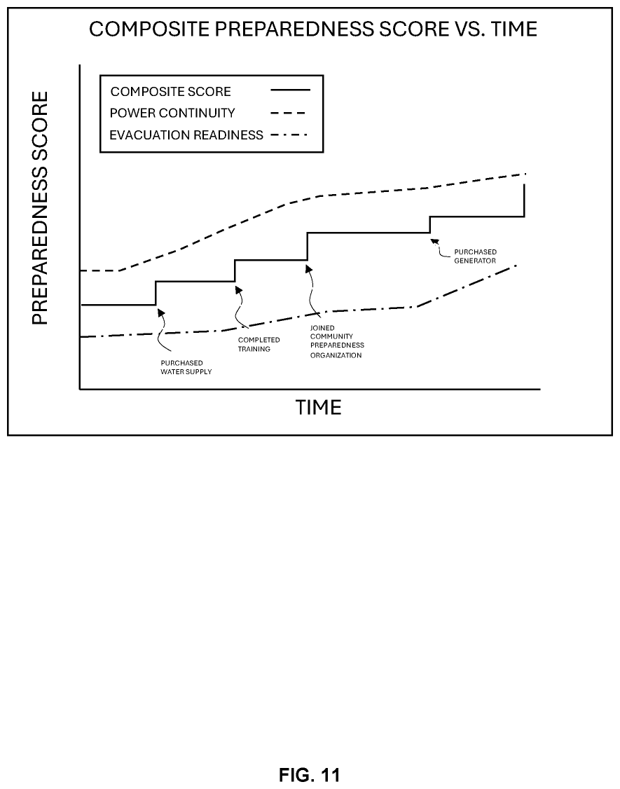

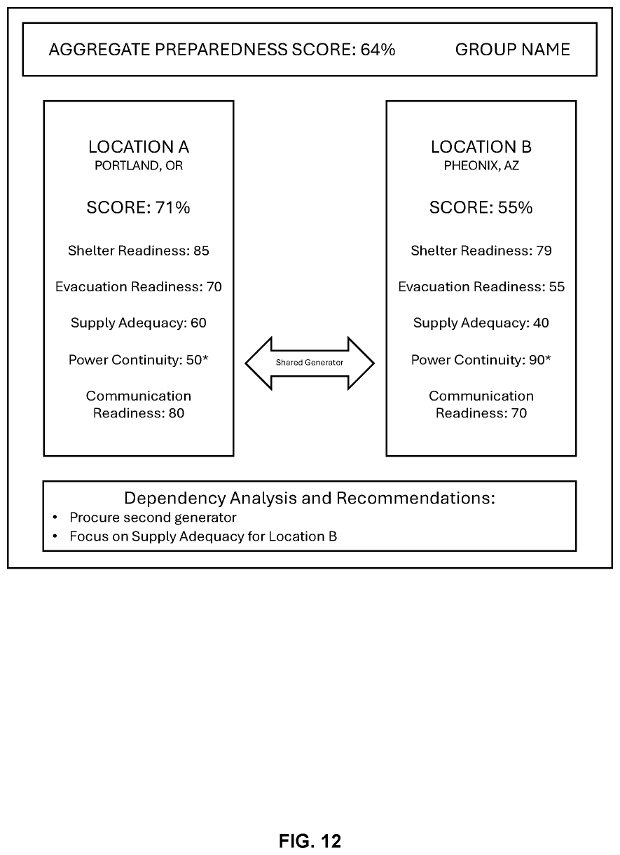

The platform includes specific user interface features that present the scoring and planning outputs to the user in an interactive and informative manner.
Score and Sub-Score Dashboard With Drill-Down (FIG. 10). The primary dashboard view displays the user's composite preparedness score prominently, using a numeric value and an accompanying visual gauge (e.g., a circular progress indicator, a horizontal bar, or a color-coded scale). Below or adjacent to the composite score, the dashboard presents the plurality of sub-scores as individually selectable elements (e.g., cards, tiles, or labeled segments of a multi-part chart), each labeled with its preparedness dimension name and displaying its numeric value and a visual indicator of its status relative to its target threshold. When the user selects a sub-score element, a drill-down panel expands to reveal: the contributing-factor breakdown for that sub-score, showing which input data elements (hazard data values, dependency statuses, preference settings) most significantly influenced the score; the specific critical dependencies that affected the sub-score (if any); and the recommended action items from the preparedness plan that are associated with that sub-score dimension, with their predicted impact ranges.
Preparedness Trajectory Visualization (FIG. 11). The trajectory view presents a time-series chart with the composite preparedness score and, optionally, individual sub-scores plotted on the vertical axis and chronological time on the horizontal axis. Event markers are positioned on the timeline at points corresponding to: task-completion events (annotated with the name of the completed action, e.g., “purchased 72-hour water supply”); hazard-data-change events (annotated with the nature of the change, e.g., “wildfire risk zone reclassification”); and, in some embodiments, external events such as actual emergency events in the user's area. The trajectory view enables the user to visually correlate specific actions and events with changes in their preparedness score over time, reinforcing the feedback loop and motivating continued engagement with the preparedness plan.
Temporal Score History. The platform maintains a temporal score history data structure that records, after each re-computation triggered by a task completion or a hazard data change, the composite score value, the individual sub-score values, and the associated timestamp. This score history enables the platform to present a preparedness trajectory visualization (illustrated in FIG. 11) showing how the user's preparedness has improved over time and correlating score changes with specific actions and events.
Multi-Location Comparison View (FIG. 12). For multi-user/multi-location embodiments the platform presents a comparison view that simultaneously displays per-location composite scores and sub-score summaries for two or more geographic locations. The comparison view may use a side-by-side layout, a card-based layout, or a map-based layout in which location markers are sized or colored based on their composite scores. Visual indicators—such as connecting lines, shared-resource icons, or dependency arrows—denote cross-location dependencies, highlighting situations where one location's preparedness affects another location's score (e.g., a shared generator dependency or a cross-location medication supply arrangement). The aggregate preparedness score for the group or organization is displayed in a summary position, providing a unified view of overall preparedness alongside the per-location detail.

### Data Structures

The following data structures are representative implementations used across the embodiments described herein. Persons skilled in the art will appreciate that equivalent data structures may be used without departing from the scope of the invention.
User Preparedness Profile. A data record comprising: a unique user identifier; one or more geographic location identifiers (e.g., latitude/longitude pairs, street addresses, census-tract codes); a hazard-preference vector mapping hazard type identifiers to user-assigned importance weight values; budget constraint values; time constraint values; a critical-dependency list where each entry comprises a dependency type identifier, one or more environmental or power requirements, and a criticality ranking value; and, optionally, household composition data (number of occupants, ages, mobility status).
Normalized Hazard Vector. A data structure comprising, for each geographic location, a set of hazard type identifiers each associated with a normalized severity value on a common scale, a data source identifier indicating the source of the underlying hazard data, a spatial resolution indicator, and a data freshness timestamp indicating when the hazard data was last updated.
Sub-Score Record. A data structure comprising: a preparedness dimension identifier; a numeric sub-score value; a contributing-factor breakdown listing the data elements and conditions that most significantly influenced the sub-score; a model version identifier indicating which sub-score computation implementation produced the sub-score; and a computation timestamp.
Composite Score Record. A data structure comprising: the composite preparedness score value; a reference to the plurality of sub-score records that contributed to the composite score; the aggregation function parameters used; and a computation timestamp.
Preparedness Plan Record. A data structure comprising: a list of action items, each action item comprising an action identifier, a description, a target sub-score dimension, a predicted sub-score impact range, an estimated cost, an estimated time-to-complete, a priority rank, and a completion status indicator; constraint parameters reflecting the user's budget and time preferences; and a plan-generation timestamp.
Group and Organization Data Structures. A group data structure comprising: a group identifier; a list of associated user profile identifiers; per-user role assignments; and a cross-location dependency graph. An organization profile data structure extending the group data structure with organizational metadata, compliance thresholds, and administrative configuration parameters.
Temporal Score History. A data structure comprising a time-ordered sequence of composite score records and associated sub-score records, enabling temporal analysis of preparedness score trends.
Model Registry Record. A data structure comprising, for each registered sub-score computation implementation: a unique implementation identifier; a version identifier; a preparedness dimension identifier; an implementation type descriptor (e.g., rule-based, weighted-sum, ML-model); input-parameter specifications; and deployment metadata.

### Embodiment D: Optional Inventory and Sensor Integrations

In another embodiment (Embodiment D), the platform optionally receives supplemental data from inventory management and/or connected sensor sources to enrich the inputs available to the modular scoring engine. This embodiment is a cross-cutting enhancement and is explicitly not required for the core scoring and planning functionality of the platform.
Inventory Management Sub-Module. In some embodiments, the platform includes an inventory management sub-module that allows users to log emergency supplies (e.g., water, non-perishable food, batteries, flashlights, first-aid supplies, medications) with quantities and expiration dates. The inventory data is stored as part of the user's preparedness profile and is provided to relevant sub-score computation units as a supplemental input. For example, the supply-adequacy sub-score computation unit may evaluate whether the user's logged water stores meet the recommended gallons-per-person-per-day standard for the user's household size over a recommended minimum duration (e.g., three days or fourteen days depending on the user's preferences and hazard profile). Expiration dates may trigger notifications and plan adjustments when supplies approach or pass their expiration.
Sensor Interface. In some embodiments, the platform includes a sensor interface that receives data from connected home devices. For example, a smart smoke detector may report operational status (functional or fault condition); a UPS (uninterruptible power supply) may report battery level and estimated runtime; a water-leak sensor may report whether moisture has been detected. Sensor data, when available, updates the inputs to relevant sub-score computation units in near real-time. For example, if a UPS reports a full charge, the power-continuity sub-score computation unit may reflect this as a positive factor; if the UPS reports a depleted battery, the sub-score may degrade accordingly.
Explicit Architectural Separation. The scoring engine is architecturally designed to operate with or without inventory data and sensor data. When these optional data sources are absent, the sub-score computation units use default assumptions (e.g., national average supply levels, no backup power assumed unless declared by the user) or user-provided estimates as fallback inputs. This architectural separation ensures that the core invention—personalized preparedness scoring and planning based on location hazard data, user preferences, and critical dependencies—functions fully without requiring any inventory tracking or sensor hardware.

Embodiment D reinforces that inventory and sensor integrations are enhancements that improve scoring precision when available but are not prerequisites for the core operation of the platform. This explicit separation distinguishes the platform from prior art systems that depend on smart-device data or sensor networks as mandatory inputs for home health or property scoring.

### Computing Environment

The platform may be implemented on a variety of computing environments. In one implementation, the platform is deployed as a cloud-hosted service (SaaS) in which the hazard ingestion module, scoring engine, planning engine, and coordination manager execute on one or more remote servers (e.g., virtual machines or container instances in a cloud computing environment), and user devices communicate with the servers via network interfaces (e.g., HTTPS RESTful APIs or WebSocket connections). In another implementation, the platform is deployed in a client-heavy configuration in which the scoring engine and planning engine are embedded on the user's mobile device (e.g., as part of a native iOS or Android application), with the remote server providing hazard data updates and cross-user coordination when connectivity is available. In a hybrid implementation, the platform distributes computation between client and server based on connectivity status, computational requirements, and data availability. The platform's architecture supports all three deployment configurations without requiring changes to the core scoring and planning logic, because the modular scoring engine's interface contracts and data structures remain consistent regardless of where the computation physically executes.

Processors suitable for implementing the platform include, without limitation, general-purpose microprocessors, application processors in mobile devices, and server-grade processors in cloud computing environments. Non-transitory computer-readable storage media suitable for storing the platform's instructions and data include, without limitation, solid-state drives, hard disk drives, flash memory (including NAND flash in mobile devices), and distributed storage systems in cloud environments. As used herein, “non-transitory computer-readable storage medium” expressly excludes transitory propagating signals.

### Additional Implementation Considerations

Security and Privacy. In some embodiments, the platform implements encryption of user preparedness profile data and score data both at rest (in the local data store and remote server) and in transit (during synchronization operations). In some embodiments, critical dependency data—which may include health-related information—is treated with heightened access controls and may be stored separately from general profile data with restricted access policies.
Extensibility. The platform's modular architecture enables extension to additional preparedness dimensions, additional hazard data sources, and additional action-item categories without requiring modification to the core scoring engine framework. New sub-score computation units can be developed conforming to the sub-score interface specification and registered in the model registry, and new hazard data sources can be integrated by implementing appropriate data parsers and normalization logic within the hazard ingestion and normalization module.
Scalability. In cloud-hosted deployments, the platform's architecture supports horizontal scaling of the hazard ingestion module, scoring engine, and planning engine across multiple server instances to accommodate growing numbers of users, locations, and organizations. The separation of scoring engine state from user interface state enables independent scaling of backend computation and frontend serving.

What is claimed is:

1. A computer-implemented method for generating a personalized preparedness score and a preparedness plan for at least one user associated with a household or an organization, the method performed by one or more processors and comprising: (a) receiving, via one or more user interfaces or data feeds, location-specific hazard data associated with one or more geographic locations linked to the at least one user, the location-specific hazard data identifying one or more hazard types and corresponding hazard-severity values for each of the one or more geographic locations; (b) receiving, via a user-profile intake process, user-specified preparedness preferences comprising at least a user-defined prioritization among a plurality of preparedness categories; (c) receiving, via the user-profile intake process, critical-dependency data identifying one or more critical dependencies of the at least one user, the critical dependencies selected from the group consisting of medical needs, assistive-device requirements, mobility constraints, and power-supply requirements; (d) computing, by a modular scoring engine executing on the one or more processors, a composite preparedness score for the at least one user, the computing comprising: (d-i) generating a plurality of sub-scores, each sub-score corresponding to a respective preparedness category and derived from at least a portion of the location-specific hazard data, the user-specified preparedness preferences, and the critical-dependency data, (d-ii) applying an aggregation function to the plurality of sub-scores to produce the composite preparedness score, wherein the modular scoring engine supports replacement or versioning of one or more sub-score computation units without requiring replacement of the aggregation function; (e) generating, by a planning engine executing on the one or more processors, a prioritized preparedness plan comprising a ranked set of recommended actions, the ranking determined at least in part by the composite preparedness score, the plurality of sub-scores, and the user-specified preparedness preferences; and (f) causing presentation, via the one or more user interfaces, of the composite preparedness score, the plurality of sub-scores, and the prioritized preparedness plan to the at least one user.

2. The method of claim 1, wherein receiving the location-specific hazard data in step (a) further comprises: normalizing, by a hazard-data normalization pipeline executing on the one or more processors, the hazard-severity values received from a plurality of heterogeneous data sources into a common hazard-severity scale prior to computing the plurality of sub-scores.

3. The method of claim 1, further comprising: maintaining, in a persistent data store, a score-history record comprising a time-stamped sequence of composite preparedness scores and corresponding sub-scores computed for the at least one user; and responsive to computing an updated composite preparedness score, storing the updated composite preparedness score and corresponding sub-scores in the score-history record.

4. The method of claim 1, further comprising: receiving, from the at least one user via the one or more user interfaces, an indication that a recommended action in the prioritized preparedness plan has been completed; in response to the indication, re-computing, by the modular scoring engine, at least one sub-score affected by the completed recommended action; and updating the composite preparedness score and the prioritized preparedness plan based on the re-computed at least one sub-score, thereby closing a feedback loop between user action and score state.

5. The method of claim 4, wherein updating the prioritized preparedness plan comprises: removing or re-ranking the completed recommended action within the ranked set of recommended actions and promoting one or more previously lower-ranked recommended actions based on the re-computed at least one sub-score.

6. The method of claim 1, wherein the at least one user comprises a plurality of users associated with a plurality of geographic locations, and the method further comprises: receiving respective user-specified preparedness preferences and respective critical-dependency data for each user of the plurality of users; computing, by the modular scoring engine, a respective composite preparedness score for each user of the plurality of users; and generating, by the planning engine, a coordinated preparedness plan that aggregates and reconciles the respective composite preparedness scores and respective prioritized preparedness plans across the plurality of users and the plurality of geographic locations.

7. The method of claim 6, further comprising: computing an aggregate preparedness score across the plurality of users and the plurality of geographic locations; and causing presentation of the aggregate preparedness score and per-user composite preparedness scores in a consolidated dashboard view.

8. The method of claim 1, further comprising: caching, in a local data store on a client device, at least a portion of the location-specific hazard data, the user-specified preparedness preferences, the critical-dependency data, and the modular scoring engine logic sufficient to compute the composite preparedness score; detecting, by the one or more processors of the client device, that a network connection is unavailable; and in response to detecting that the network connection is unavailable, computing the composite preparedness score and generating the prioritized preparedness plan using the cached data and logic on the client device without requiring network communication.

9. The method of claim 8, further comprising: upon detecting that the network connection has been restored, synchronizing the locally computed composite preparedness score and the prioritized preparedness plan with a remote server, including resolving conflicts between locally computed data and server-side data according to a timestamp-based or version-based conflict-resolution policy.

10. The method of claim 1, wherein the modular scoring engine comprises a plurality of independently deployable sub-score computation units, and wherein computing the composite preparedness score further comprises: selecting, from a registry of available sub-score computation units, a subset of sub-score computation units applicable to the one or more hazard types identified in the location-specific hazard data; and invoking each selected sub-score computation unit to generate a corresponding sub-score, wherein at least one sub-score computation unit is replaceable with an updated version without modifying remaining sub-score computation units or the aggregation function.

11. The method of claim 10, wherein the registry of available sub-score computation units stores, for each sub-score computation unit, a version identifier and a set of input-parameter specifications, and wherein selecting the subset comprises matching the set of input-parameter specifications against available data fields in the location-specific hazard data, the user-specified preparedness preferences, and the critical-dependency data.

12. The method of claim 1, wherein generating the prioritized preparedness plan in step (e) comprises: mapping each sub-score of the plurality of sub-scores to one or more candidate recommended actions via a sub-score-to-action mapping data structure; and ranking the candidate recommended actions based at least in part on (i) the relative deficit of each corresponding sub-score from a target sub-score threshold and (ii) the user-specified preparedness preferences.

13. The method of claim 1, further comprising: receiving, from one or more optional data sources, inventory data identifying supplies currently held by the at least one user or sensor data from one or more environmental sensors; and incorporating the inventory data or the sensor data as a supplemental input to at least one sub-score computation unit of the modular scoring engine when computing the plurality of sub-scores.

14. The method of claim 4, wherein re-computing the at least one sub-score further comprises: determining, based on the completed recommended action, a set of one or more preparedness categories affected by the completed action; re-computing only the sub-scores corresponding to the set of one or more affected preparedness categories; and leaving sub-scores corresponding to unaffected preparedness categories unchanged.

15. A system for generating a personalized preparedness score and a preparedness plan, the system comprising: one or more processors; and one or more non-transitory computer-readable storage media storing instructions that, when executed by the one or more processors, cause the one or more processors to implement: (a) a profile-management component configured to: receive and store, for at least one user associated with a household or an organization, user-specified preparedness preferences comprising at least a user-defined prioritization among a plurality of preparedness categories, and receive and store critical-dependency data identifying one or more critical dependencies of the at least one user selected from the group consisting of medical needs, assistive-device requirements, mobility constraints, and power-supply requirements; (b) a hazard-ingestion-and-normalization component configured to: receive location-specific hazard data associated with one or more geographic locations linked to the at least one user from one or more external hazard-data sources, and normalize hazard-severity values from the one or more external hazard-data sources into a common hazard-severity scale; (c) a modular scoring engine configured to: generate a plurality of sub-scores, each sub-score corresponding to a respective preparedness category and derived from at least a portion of the normalized location-specific hazard data, the user-specified preparedness preferences, and the critical-dependency data, and apply an aggregation function to the plurality of sub-scores to produce a composite preparedness score, wherein the modular scoring engine comprises a plurality of independently replaceable sub-score computation units and supports versioning such that a sub-score computation unit is replaceable without requiring modification of remaining sub-score computation units or the aggregation function; (d) a planning engine configured to generate a prioritized preparedness plan comprising a ranked set of recommended actions, the ranking determined at least in part by the composite preparedness score, the plurality of sub-scores, and the user-specified preparedness preferences; and (e) a user-interface component configured to cause presentation of the composite preparedness score, the plurality of sub-scores, and the prioritized preparedness plan to the at least one user.

16. The system of claim 15, wherein the instructions further cause the one or more processors to implement a multi-location coordination manager configured to: maintain, for a plurality of users across a plurality of geographic locations, respective composite preparedness scores and respective prioritized preparedness plans; and generate a coordinated cross-location preparedness plan that reconciles the respective prioritized preparedness plans and identifies shared or conflicting recommended actions across the plurality of geographic locations.

17. The system of claim 16, wherein the multi-location coordination manager is further configured to: compute an aggregate preparedness score across the plurality of users and the plurality of geographic locations; and present the aggregate preparedness score together with per-user and per-location composite preparedness scores in a consolidated organization dashboard.

18. The system of claim 15, wherein the one or more non-transitory computer-readable storage media comprise a local data store on a client device, and wherein the instructions further cause the one or more processors to implement an offline-operation component configured to: cache, in the local data store, at least a portion of the normalized location-specific hazard data, the user-specified preparedness preferences, the critical-dependency data, and logic of the modular scoring engine sufficient to compute the composite preparedness score; and compute the composite preparedness score and generate the prioritized preparedness plan using the cached data and logic when a network connection is unavailable.

19. The system of claim 18, wherein the instructions further cause the one or more processors to implement a synchronization component configured to: detect restoration of the network connection; and upon detection, synchronize locally computed composite preparedness scores and prioritized preparedness plans with a remote server, including applying a conflict-resolution policy to reconcile differences between local and server-side data.

20. The system of claim 15, wherein the instructions further cause the one or more processors to implement a feedback-processing component configured to: receive, from the at least one user, an indication that a recommended action in the prioritized preparedness plan has been completed; trigger re-computation, by the modular scoring engine, of at least one sub-score affected by the completed recommended action; and cause the planning engine to update the prioritized preparedness plan based on the re-computed at least one sub-score.

21. The system of claim 15, wherein the modular scoring engine further comprises: a sub-score computation unit registry storing, for each sub-score computation unit, a version identifier and an input-parameter specification; and a selection mechanism configured to match the input-parameter specification of each registered sub-score computation unit against available data fields to determine which sub-score computation units to invoke for a given user.

22. The system of claim 15, wherein the instructions further cause the one or more processors to optionally implement an inventory-and-sensor integration sub-module configured to: receive, from one or more optional data sources, inventory data identifying supplies held by the at least one user or sensor data from one or more environmental sensors; and provide the inventory data or the sensor data as supplemental input to at least one sub-score computation unit of the modular scoring engine, wherein the composite preparedness score is computable in the absence of the inventory data and the sensor data.

23. The system of claim 15, wherein the planning engine is further configured to: access a sub-score-to-action mapping data structure that maps each sub-score to one or more candidate recommended actions; and rank the candidate recommended actions based at least in part on a deficit of each corresponding sub-score from a target sub-score threshold and the user-specified preparedness preferences.

24. The system of claim 15, wherein the instructions further cause the one or more processors to maintain a score-history data structure comprising time-stamped composite preparedness scores and corresponding sub-scores, enabling presentation of preparedness-score trends over time via the user-interface component.

25. A non-transitory computer-readable medium storing instructions that, when executed by one or more processors, cause the one or more processors to perform operations comprising: (a) receiving location-specific hazard data associated with one or more geographic locations linked to at least one user of a household or an organization, the location-specific hazard data identifying one or more hazard types and corresponding hazard-severity values; (b) receiving user-specified preparedness preferences comprising at least a user-defined prioritization among a plurality of preparedness categories for the at least one user; (c) receiving critical-dependency data identifying one or more critical dependencies of the at least one user, the critical dependencies selected from the group consisting of medical needs, assistive-device requirements, mobility constraints, and power-supply requirements; (d) computing, by a modular scoring engine, a composite preparedness score for the at least one user, the computing comprising: (d-i) generating a plurality of sub-scores, each sub-score corresponding to a respective preparedness category and derived from at least a portion of the location-specific hazard data, the user-specified preparedness preferences, and the critical-dependency data, (d-ii) applying an aggregation function to the plurality of sub-scores to produce the composite preparedness score, wherein the modular scoring engine supports replacement or versioning of one or more sub-score computation units without requiring replacement of the aggregation function; (e) generating a prioritized preparedness plan comprising a ranked set of recommended actions, the ranking determined at least in part by the composite preparedness score, the plurality of sub-scores, and the user-specified preparedness preferences; and (f) causing presentation of the composite preparedness score, the plurality of sub-scores, and the prioritized preparedness plan to the at least one user.
